(19) United States
(12) Patent Application Publication
(10) Pub. No.: US 2018/0181125 A1
(43) Pub. Date: Jun. 28, 2018

(54) ON-GROUND VEHICLE COLLISION AVOIDANCE UTILIZING UNMANNED AERIAL VEHICLES

(71) Applicant: Honeywell International Inc., Morris Plains, NJ (US)

(72) Inventor: Christophe Ceccom, Blagnac (FR)

(21) Appl. No.: 15/388,783

(22) Filed: Dec. 22, 2016

(51) Int. Cl. G05D 1/00; G08G 5/00; G08G 5/02; G08G 5/04; B64C 39/02; B64D 47/08; G08G 5/06

(52) U.S. Cl. CPC G05D 1/0083; G08G 5/0086; G08G 5/02; G08G 5/04; B64C 2201/12; B64D 47/08; G08G 5/065; B64C 2201/021; B64C 39/024

(57) ABSTRACT

On-ground vehicle collision avoidance utilizing unmanned aerial vehicles are provided. In one embodiment, a vehicle collision avoidance method using a UAV comprises: receiving dispatch instructions at a hazard sensing UAV, the dispatch instructions comprising at least an assigned vehicle identification for an assigned vehicle to be escorted by the hazard sensing UAV; determining an escort rendezvous point and an escort destination point associated with the assigned vehicle and positioning the UAV at the escort rendezvous point; escorting the assigned vehicle with the UAV from the escort rendezvous point to the escort destination point; while escorting the assigned vehicle, scanning a planned path of travel for the assigned vehicle for hazards with at least one object detection sensor onboard the UAV and generating hazard data from information of newly detected hazards captured by the object detection sensor; and transmitting hazard data from the UAV to a hazard data aggregation system.

### BACKGROUND

Collisions that occur at airports between on-ground aircraft and other objects can result significant damage to aircraft. In addition to the airlines incurring expenses associated with repairing the aircraft, other expenses include the dispatch of a replacement aircraft and potential costs to accommodate displaced passengers. Existing efforts to address on-ground aircraft collisions typically involve the installation of collision avoidance sensors and systems on aircraft that enable an aircraft to autonomously detect potential collision hazards and warn the pilots of such hazards. However, these systems can be expensive and the costs associated with equipping each aircraft of an airline's fleet with such systems can be unattractive from a business perspective. For example, one problem with installing additional equipage on aircraft is that hazard detection sensors not only need to have sufficient sensitivity for performing the needed task, but they also may need to meet certification specifications into order to work with other onboard avionics. One proposed solution has been to equip only a certain percentage of aircraft with advanced hazard sensors, and then share the collected hazard data with other aircraft that may not be equipped with such hazard sensors. However, this solution still requires sensors to be developed and certified for that percentage of aircraft so equipped with the sensors and supplying hazard information. Furthermore, the solution pre-supposes that at least a minimum threshold number of aircraft performing hazard data collecting and sharing will be present at a given airport at any one time to provide the needed coverage. Thus even if a minimal number of equipped aircraft can be statistically expected, there may still be times when coverage is lacking.

For the reasons stated above and for other reasons stated below which will become apparent to those skilled in the art upon reading and understanding the specification, there is a need in the art for system and methods for on-ground vehicle collision avoidance utilizing unmanned aerial vehicles.

### SUMMARY

The Embodiments of the present disclosure provides systems and methods for on-ground vehicle collision avoidance utilizing unmanned aerial vehicles and will be understood by reading and studying the following specification.

In one embodiment, a vehicle collision avoidance method using a unmanned aerial vehicles (UAV) comprises: receiving dispatch instructions at a hazard sensing UAV, the dispatch instructions comprising at least an assigned vehicle identification for an assigned vehicle to be escorted by the hazard sensing UAV; determining an escort rendezvous point and an escort destination point associated with the assigned vehicle and positioning the UAV at the escort rendezvous point; escorting the assigned vehicle with the UAV from the escort rendezvous point to the escort destination point; while escorting the assigned vehicle, scanning a planned path of travel for the assigned vehicle for hazards with at least one object detection sensor onboard the UAV and generating hazard data from information of newly detected hazards captured by the object detection sensor; and transmitting hazard data from the UAV to a hazard data aggregation system.

### DRAWINGS

Embodiments of the present disclosure can be more easily understood and further advantages and uses thereof more readily apparent, when considered in view of the description of the preferred embodiments and the following figures in which:

FIG. 1 is a diagram illustrating an on-ground vehicle collision avoidance system of one embodiment of the present disclosure;

FIGS. 1A and 1B are diagrams illustrating scenarios of an on-ground vehicle collision avoidance system of one embodiment of the present disclosure in operation;

FIG. 2 is block diagram illustrating a hazard sensing UAV of one embodiment of the present disclosure;

FIG. 3 is a flow chart illustrating a method of one embodiment of the present disclosure; and

FIG. 4 is a diagram illustrating a UAV landing assistance service of one embodiment of the present disclosure.

In accordance with common practice, the various described features are not drawn to scale but are drawn to emphasize features relevant to the present disclosure. Reference characters denote like elements throughout figures and text.

### DETAILED DESCRIPTION

In the following detailed description, reference is made to the accompanying drawings that form a part hereof, and in which is shown by way of specific illustrative embodiments in which the embodiments may be practiced. These embodiments are described in sufficient detail to enable those skilled in the art to practice the embodiments, and it is to be understood that other embodiments may be utilized and that logical, mechanical and electrical changes may be made without departing from the scope of the present disclosure. The following detailed description is, therefore, not to be taken in a limiting sense.

As presented in this disclosure, hazard sensors rather than being placed on-board vehicles are instead equipped into unmanned aerial vehicles (UAV). For example, when the vehicles are aircraft, the UAV will escort the aircraft as they taxi across an airport tarmac. As discussed below, hazard sensing UAV collects hazard data which is then a) communicated to a ground station, aggregated with other hazard data, and then shared with vehicle, and/or b) directly shared with the vehicle. In this way, crews operating the vehicle are aware of on-ground hazards and obstacles that they might encounter. Moreover, the hazard sensing UAV will escort the vehicle creating a sensory envelope around the vehicle, even for vehicles that do not themselves possess advanced hazard sensors.

The hazard sensing UAV may rendezvous with the vehicle at a designated point. For example. In some embodiments, the hazard sensing UAV may rendezvous with an incoming arriving aircraft at a designated point on the landing runway. From there, the hazard sensing UAV scans the ground of the aircraft's path as it taxis to either a gate, hanger, or other assigned destination at the airport. Conversely, in some embodiments, the hazard sensing UAV may rendezvous with a departing aircraft from its boarding location and will scan the ground of the aircraft's path as it taxis to its assigned runway for takeoff. For either departing or arriving aircraft, the hazard sensing UAV may perform a scan of the runway for hazards. In some embodiments, the hazard sensing UAV may actually remotely drive on-ground taxiing aircraft, using its knowledge of airport ground hazards and assigned rendezvous and separation locations. Furthermore, in some embodiments, a hazard sensing UAV assigned to an arriving aircraft may also provide landing aids to the aircraft. For example, prior to the aircraft's landing, a hazard sensing UAV may position itself at an assigned point near the end of a runway and transmit a landing assistance signal (such as an instrument landing system (ILS) signal or the like) that the aircraft may follow to the runway. Then, once the aircraft reaches a predetermined proximity to the runway, the hazard sensing UAV may relocate itself to the assigned rendezvous point and transition to its hazard detections and escort function. An aircraft may utilize its standard complement of communications channels to receive aggregated hazard data from the airport's hazard data aggregation system, and use the same communication channels when direct communication with the hazard sensing UAV is necessary. As such, any aircraft with standard communications technology may take advantage of, and benefit from, fresh hazard data pertinent to its immediate proximity.

Although much of this disclosure discusses example embodiment involving aircraft, it should be understood that the full scope of embodiments of the present disclosure are not limited to aircraft but may extend to any other vehicle which may benefit from collision avoidance enhanced by a hazard sensing UAV such as described herein. Other vehicles such as, but not limited to helicopters, cars, trucks, trains, boats ships, etc. that may at times need to follow a designated path may fall within the scope of embodiments of the present disclosure. Accordingly, in alternate embodiments, such alternate vehicles may be substituted in place of an aircraft in the illustrative embodiments discussed herein.

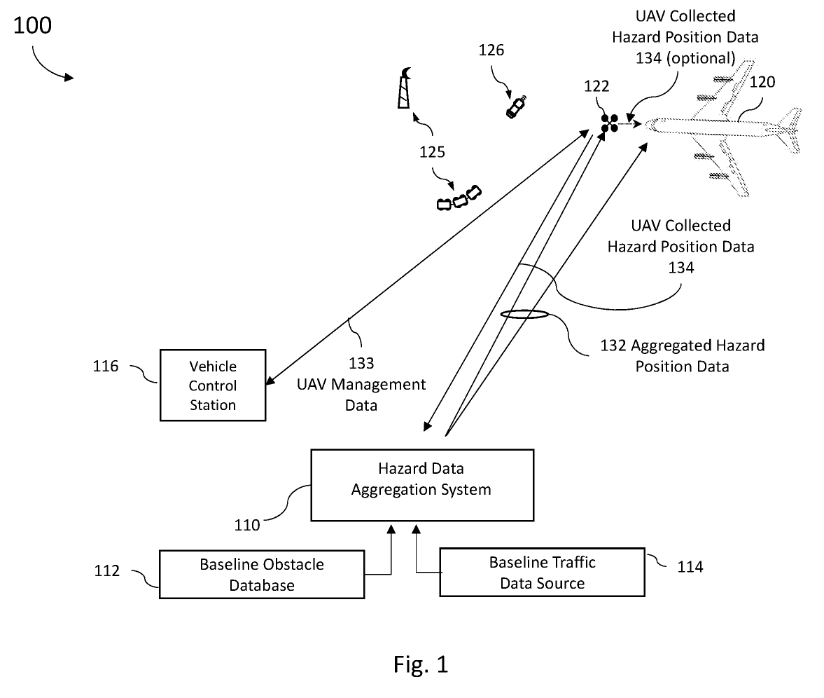

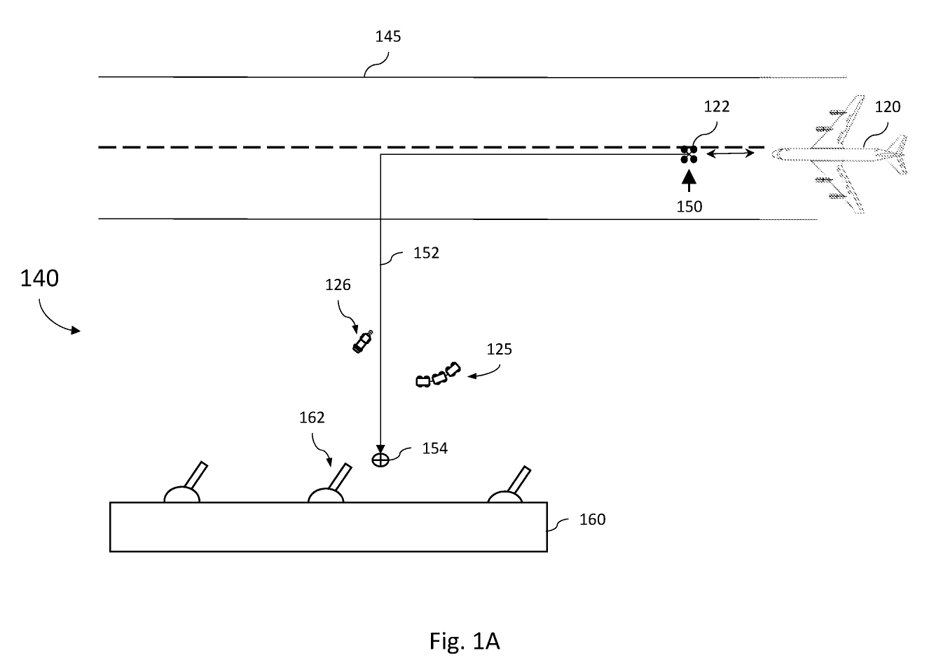

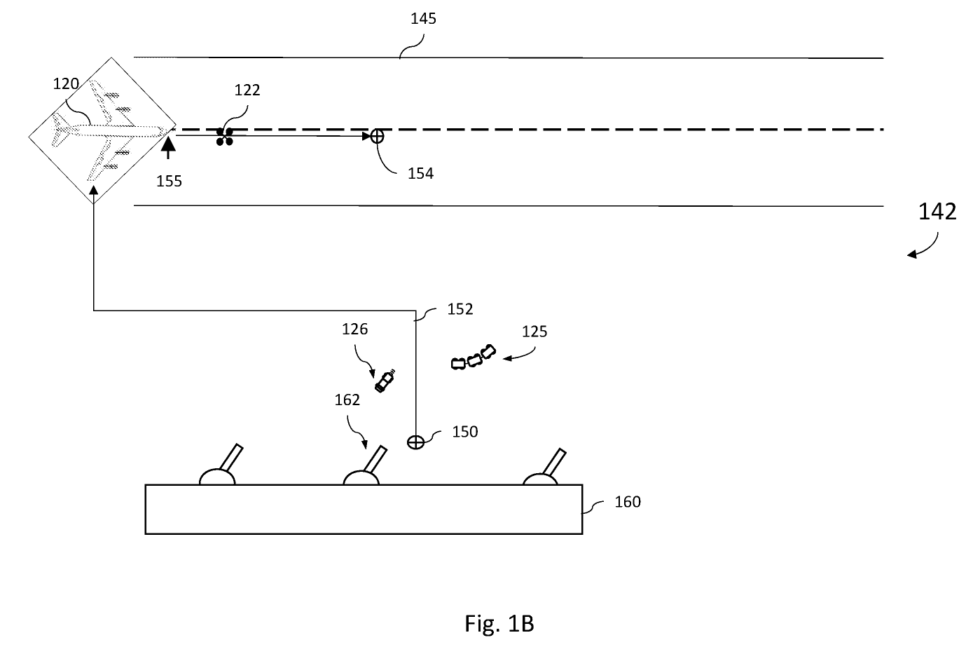

FIG. 1 is a diagram illustrating an on-ground vehicle collision avoidance system 100 of one embodiment of the present disclosure utilizing shared vehicle hazard sensor data collected from hazard sensing UAVs. Utilizing system 100, pilots of various vehicles (such as aircraft 120) and/or operators of moving ground vehicles (such as truck 126) can be made aware of the position of various ground hazards (such as shown at 125 and 126). As further described below, ground hazards 125 and 126 may comprise passive (non-cooperative) or active (co-operative) obstacles, or ground traffic, or some combination thereof. System 100 comprises a ground based hazard data aggregation system 110 that includes datalink functionality to wirelessly transmit uplink data to vehicles 120 and wirelessly receive downlink data from those vehicles 120. Such wireless datalink communications may be established, for example, using any available datalink technology such as, but not limited to, airport wireless LAN (e.g. WiFi, WIMAX), Automatic Dependent Surveillance-Broadcast (ADS-B), satellite communications (SATCOM), cellular data communications, UAV command and control link, and the like.

With embodiments of the present disclosure, each of the vehicles 120 may be escorted by at least one hazard sensing UAV 122. Each hazard sensing UAV 122 comprises what is referred to herein as an active onboard ground hazard collision avoidance systems and are equipped with on-board ground collision avoidance sensors. Each hazard sensing UAV 122 further contributes hazard position data they have collected with the ground based hazard data aggregation system 110 (such as shown by Hazard Position Data datalink 134). Vehicles, such as aircraft 120 may receive and utilize aggregated hazard position data transmitted by ground based hazard data aggregation system 110 and may be referred to herein as hazard data subscriber vehicles or aircraft. Hazard data subscriber vehicles receive aggregated hazard position data via a datalink 132 from the ground based hazard data aggregation system 110. Moreover, each vehicle 120 comprises an on-board ground hazard collision avoidance system that utilizes aggregated hazard position data uplinks 132 to become aware (and makes its crew aware) of potential collision hazards.

As the term is used herein, a “hazard” may comprise one of several different types of objects. For example, one type of hazard comprises static objects referred to herein as “obstacles.” The term obstacle may include static objects such as buildings, permanent gate equipment, airport equipment such as antennas or other sensors, construction equipment, or parked ground vehicles (i.e., airport vehicles parked in designated long-term parking location). Obstacles may comprise passive (or non-cooperative) obstacles that are not described in the airport's baseline obstacle database or do not actively communicate their presence as a hazard to other ground systems. For example, hazards 125 may comprise a non-cooperative hazard such as a stationary baggage cart or an airport antenna. Alternately, an obstacle may comprise an active (or cooperative) obstacle such as hazard 126. That is, hazard 126 is cooperative meaning that it may communicate its own presence as a hazard to other ground systems.

FIG. 1 illustrates an example implementation where a moving ground vehicle hazard 126 (for example, a baggage truck) is present and may present a collision hazard to vehicle 120. Another type of hazard comprises dynamic objects referred to herein as “ground traffic” or simply “traffic”. It should be noted that in some implementations, a moving ground vehicle such as hazard 126 may present a hazard to vehicle 120 while also itself being a recipient of hazard position data to become aware of ground based hazards. As such, embodiments of systems comprising only non-aircraft vehicles sharing hazard data as described herein, or combinations of on-ground aircraft and non-aircraft vehicles sharing hazard data as described herein, are expressly contemplated.

The ground based hazard data aggregation system 110 may comprise one or more processors coupled to a memory. In operation, system 110 compiles and stores hazard position data for both airport obstacles and traffic in a database. As updates to the database are received, those updates are aggregated, and updated hazard data is transmitted to the subscribing vehicles 120 as the aggregated hazard position data 132. The obstacle and the traffic hazard position data in the database of ground based hazard data aggregation system 110 can comprise of a combination of baseline and vehicle collected position data, which may be provided by one or more ground based hazard detection systems. For example, in one embodiment, ground based hazard data aggregation system 110 is coupled to a baseline obstacle database 112 which includes permanent airport buildings and structures (for example, terminals, communications towers and equipment, hangers and other service buildings) and may change over extended periods, but not in the course of a day's operation. When hazard position data collected by hazard sensing UAV 122 indicates that airport's terminal and/or other service buildings and obstacles have not moved from their baseline positions, sharing of such information to subscribing vehicles 120 should not be necessary since it is already captured in the baseline obstacle database. Similarly, in some embodiments, ground based hazard data aggregation system 110 may also be coupled to a source of baseline traffic data 114 (also referred to herein as baseline traffic data source 114). For example, the baseline traffic data from data source 114 may include Automatic Dependent Surveillance-Broadcast (ADS-B), Automatic Dependent Surveillance-Re-broadcast (ADS-R) traffic surveillance information, or Advanced Surface Movement Guidance & Control System (A-SMGCS) traffic surveillance information for aircraft and ground vehicles. In one implementation, the airport's ground traffic control system maintains a database of the current position of all managed ground traffic, which is accessed by ground based hazard data aggregation system 110 and incorporated into the aggregated hazard position data send to subscriber vehicles 120. Additional moving hazards sensed and reported by hazard sensing UAVs 120 in the vehicle collected hazard position data would be aggregated and by system 110 and also shared to subscriber vehicles 120 via the uplinks 132. Further details regarding configurations for ground based hazard data aggregation systems may be found in U.S. patent application Ser. No. 14/973,411 entitled “ON-GROUND VEHICLE COLLISION AVOIDANCE UTILIZING SHARED VEHICLE HAZARD SENSOR DATA” which is incorporated herein by reference in its entirety.

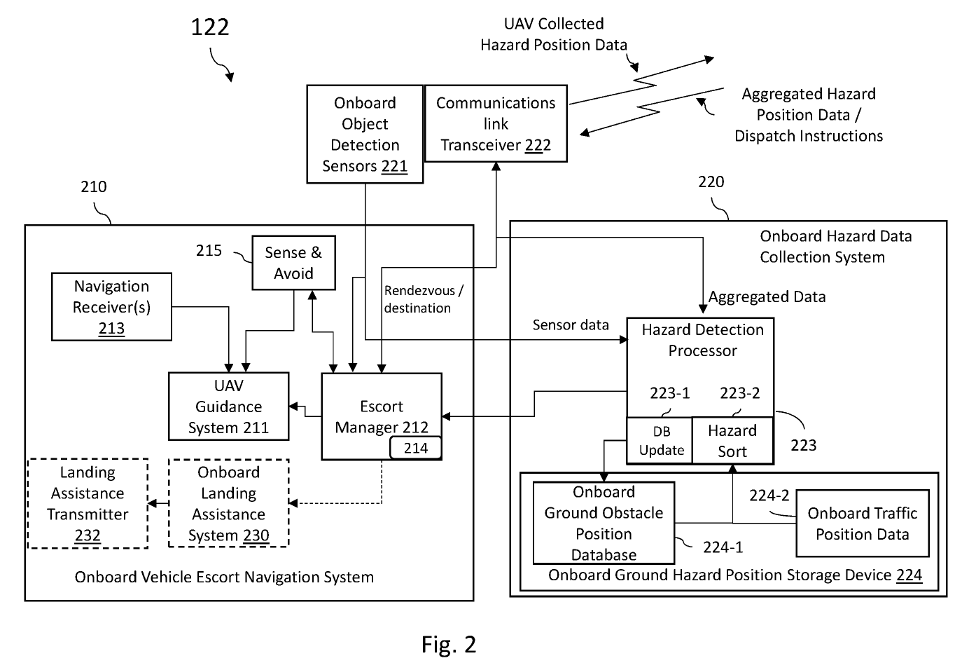

In some embodiments of the present disclosure, such as shown in FIG. 2, each hazard sensing UAV 122 comprises a vehicle escort navigation system 210, an on-board hazard data collection system 220, one or more object detections sensors 221 and at least one communication link transceiver 222. Communications link transceiver 222 comprise radio communications electronics that establish the various communication links used for both vehicle escort and hazard data communications functions. These communication links may include but are not limited to SATCOM links, WiFi (i.e., IEEE 802.11) communications links, or cellular data communications links, for example. Object detection sensors 221 may comprise one or more imaging sensors known to those of skill in the art such as, but not limited to, LIDAR or RADAR sensors, visible spectrum cameras, infrared cameras, or Electro-Optical (EO)/Infrared (IR) Sensors, for example. In other embodiments, the object detection sensors 221 may comprise sensors other than those that collect images. As such, information captured by the object detection sensors 221 may comprise either image data or non-image information. Information (either image data or non-image data) captured by the object detection sensors 221 may be utilized by the on-board hazard data collection system 220 to identify previously undetected objects that may present a collusion hazard to the vehicle 120. Additionally, information captured by the object detection sensors 221 may also be utilized by the vehicle escort navigation system 210 to track and control the relative position of the hazard sensing UAV 110 with respect to the vehicle 120 it is escorting. That is, data from object detection sensors 221 may be used to maintain the UAV 110 at a predetermined station or position with respect to the moving aircraft 120. For example, in one embodiment, vehicle escort navigation system 210 maintains UAV 110 at a regulated position directly in front of aircraft 120 so that the UAV 110 may scan for collusion hazards along aircraft 120's path of travel.

As shown in FIG. 2, escort navigation system 210 includes a UAV guidance system 211 coupled to an escort manager 212 and further coupled to at least one navigation receiver 213. The escort manager 212 is coupled to the communications link transceiver 222. From the transceiver 222, the escort manager 212 receives dispatch instructions for escorting arriving or departing vehicles 120. In one embodiment, the dispatch instructions are transmitted to the UAV 122 as UAV management data 133 from a vehicle control station 116. In one embodiment, the vehicle control station 116 may comprise an airport control tower or other facility from which complex ground traffic is coordinate. For example, in one embodiment, dispatch instructions from vehicle control station 116 assigning an escort task to the UAV 122 comprise an assigned vehicle identifier and may further include a designated escort rendezvous point, and/or an escort destination point. The assigned vehicle identifier (which, for example, may be a flight number, registration number, or some other unique identifier) defines the specific vehicle the UAV 110 is assigned to escort. The designated escort rendezvous point indicates the location where the UAV 110 should meet the vehicle being escorted and the escort destination point indicates the location where the UAV 110 is to escort that vehicle to. If for some reason a UAV self-detects a condition which could preclude it from completing its escort (for example, if the UAV detects it is low on fuel) it may respond by declining the dispatch instructions.

For example, FIG. 1A illustrates a scenario at 140 where vehicle 120 comprises an aircraft arriving on a runway 145. In that case, the escort rendezvous point (shown at 150) is a location on the runway 145 designating where the UAV 122 is to meet the arriving aircraft. The escort destination point (shown at 154) is a location designating where the UAV 122 is to escort vehicle 120 to. In this case, the path 152 from the escort rendezvous point 150 to the escort destination point 154 brings the vehicle to a specific gate 162 of a terminal 160. As further discussed herein, while UAV 122 is escorting vehicle 120 to the escort destination point 154, it is also scanning the path 152 for the presence of potential collision hazards (such as shown at 125, 126). When UAV finds a previously unidentified hazard along path 152 (that is, a newly detected hazard which was previously not stored in an onboard hazard data collection system 220 database) the onboard hazard data collection system 220 will transmit UAV collected hazard position data 134 indicating the position of that new hazard to the hazard data aggregation system 110.

Conversely, FIG. 1B illustrates a scenario at 142 where vehicle 120 comprises an aircraft cleared to depart from runway 145. In that case, the escort rendezvous point 150 is the gate 162 where the UAV 122 is to meet the departing aircraft 120. The escort destination point 154 is the location on runway designating where the UAV 122 is to escort vehicle 120 to. While UAV 122 is escorting vehicle 120 to the escort destination point 154, it is also scanning the path 152 for the presence of potential collision hazards (such as shown at 125, 126). When UAV finds a previously unidentified hazard along path 152 (that is, a newly detected hazard which was previously not stored in an onboard hazard data collection system 220 database) the onboard hazard data collection system 220 will transmit UAV collected hazard position data 134 indicating the position of that new hazard to the hazard data aggregation system 110 (and optionally directly to vehicle 120). In some embodiments, the UAV 122 may first escort vehicle 120 to a departure staging point (shown at 155) before the vehicle 120 receives its final clearance for departure. After final clearance for departure is received, UAV 122 continues to escort vehicle 120 up to the escort destination point 154 at which point it breaks away from escorting the vehicle 120. In some embodiments, an escort destination point 154 may be dynamically determined by the UAV 122. For example, the escort manager 212 may receive vehicle 120 velocity information from sensors 221 and breakaway to cease escorting once the vehicle 120 reaches a breakaway velocity threshold (which may correspond to a particular aircraft's takeoff velocity, or the maximum velocity of UAV 122, for example). In some embodiments, the breakaway velocity threshold for a particular vehicle 120 may be derived from information received in the dispatch instructions. In some embodiments, if a new hazard is detected on runway 145 as vehicle 120 is accelerating to its takeoff velocity, the onboard hazard data collection system 220 may transmit UAV collected hazard position data 134 directly to vehicle 120 as well as hazard data aggregation system 110.

Moreover, in some embodiments the object detection sensors 221 will measure both the relative position and velocity of aircraft 120, and based on this information, escort manager 212 controls the UAV guidance system 211 to maintain the UAV 122 a distance in front of aircraft 120 as a function of the aircraft's speed. That is, when aircraft 120 is traveling at a higher speed, the UAV 122 maintains a greater distance in front of aircraft 120 than when aircraft 120 is traveling at lower speeds. By doing so, UAV 122 is more likely to detect and communicate a collision hazard in the aircraft's path in sufficient time for the aircraft 120 to avoid the hazard. In some embodiments, a specific sense & avoid system 215 (which may be either separate from or integrated within the escort manager 212) is utilized to enable such safety distance management.

In some embodiments, one or both of the designated escort rendezvous point 150 and the escort destination point 154 may be communicated within the dispatch instructions as specific geographic coordinates. In other embodiments, they may comprise a descriptive location designation (such as a runway or gate number) which the UAV 110 may then convert or map into coordinates. In some embodiments, the dispatch instructions may further indicate to the escort manager 212 whether the UAV 110 is escorting the assigned vehicle 120 for the purpose of a vehicle departure or arrival. In other embodiments, the escort manager 212 may infer whether the dispatch for the purpose of a vehicle departure or vehicle arrival based on the where the designated escort rendezvous point 150 and escort destination point 154 are located. For example, receipt of dispatch instructions which comprise a designated escort rendezvous point 150 located on a runway 145 may cause the escort manager 212 to enter an arriving vehicle mode appropriate for escorting an arriving aircraft (such as illustrated in FIG. 1A). Receipt of dispatch instructions which comprise a designated escort rendezvous point 150 indicating an airport gate number may cause the escort manager 212 to enter a departing vehicle mode appropriate for escorting a departing aircraft (such as illustrated in FIG. 1B). Once the dispatch instructions are received and interpreted by the escort manager 212, it can communicate the location of the designated escort rendezvous point 150 to the UAV guidance system 211, which will autonomously control the flight of UAV 110 to travel to the escort rendezvous point 150.

As shown in FIG. 2, the UAV guidance system 211 can be coupled to a navigation receiver 213 which provides position and navigation solution data to the UAV guidance system 211. In alternate embodiments, the navigation receiver 213 may comprise one or more of a Global Navigation Satellite System (GNSS) receiver (such as a global positioning system receiver), a ground-based augmentation system (GBAS) receiver, or other electronics for obtaining precision position and navigation data. In some embodiments, the escort manager 212 may comprise in a memory a facility map 214 that indicates preferred travel paths 152 from various escort rendezvous points 150 to escort destination point 154. The escort manager 212 may communicate that path 152 to the UAV guidance system 211, which in turn will control the flight of the UAV 110 along that path 152. In other embodiments, the escort manager 212 may dynamically determine path 152 from the escort rendezvous point 150 to the escort destination point 152, and communicate that path 152 to the UAV guidance system 211 to control the flight of the UAV 110 to the escort destination point 154.

In some embodiments, the dispatch instructions may be automatically generated at the vehicle control station 116 and transmitted to the UAV 110, triggered by for example, an imminent arrival of an incoming vehicle, pre-established departure or arrival schedules, or upon issuance of an arrival or departure clearance. In other embodiments, the crew or operator of the vehicle 120 itself may manually initiate an escort request for dispatch instructions to be transmitted to the UAV 110. In some embodiments, such an escort request manually initiated from the vehicle 120 may designate one or both of a requested escort rendezvous point 150 and/or a requested escort destination point 154.

In still other embodiments, the dispatch instructions may include the assigned vehicle identifier without information designating one or both of the escort rendezvous point or the escort destination point. In such an embodiment, the escort manager 212, once it has received the assigned vehicle identifier, may begin to monitor communications to and from the assigned vehicle 120 and identify the one or both of the escort rendezvous point 150 and the escort destination point 154 from the intercepted communications. For example, in one embodiment once the escort manager 212 has received an assigned vehicle identifier associated with an arriving aircraft 120, it can monitor Controller-pilot data link communications (CPDLC) communications between the aircraft 120 and an airport control center/tower to identify which runway 140 the aircraft 120 has received a clearance to land on (thus inferring an escort rendezvous point 150) and which gate the aircraft has been assigned to taxi to (thus inferring an escort destination point 154). Conversely, for a departing aircraft 120, escort manager 212 can monitor CPDLC communications between the aircraft 120 and the airport control tower to identify which gate the aircraft has been cleared to push-off from (thus inferring an escort rendezvous point 150) and which runway 140 the aircraft has been assigned to take-off from (thus inferring an escort destination point 154). Utilization of intercepted communications by escort manager 212 has the advantage of not requiring duplicative transmission of information to the UAV 122 that has already been conveyed to the vehicle 120. In some embodiments, information entered into the Flight Management System of an aircraft may be conveyed to the UAV 122 and the escort rendezvous point 150 and escort destination point 154 derived from that information.

With respect to hazard processing either prior to, or while escorting vehicle 120, the on-board hazard data collection system 220 includes an onboard hazard detection processor 223 and an onboard ground hazard position data storage device 224. The system 220 shown in FIG. 2, based on objects detected by object detection sensors 221, generates hazard position data that is shared with the Ground Based Hazard Data Aggregation System 110. Measurements (including object position, speed, and/or direction) obtained from object detection sensors 221 may be processed by onboard hazard detection processor 223 into hazard position data which is stored in onboard ground hazard position data storage device 224. As shown in FIG. 2, onboard ground hazard position data storage device 224 may comprise an onboard ground obstacle position database 224-1 and a source of onboard traffic position data 224-2 (which may be stored in device 224 as a list, a database, or other format). The collected hazard position data is transmitted to Ground Based Hazard Data Aggregation System 110 via a UAV Collected Hazard Position Data downlink 134. In some embodiments, the onboard Flight Management System of vehicle 120 can be used to keep control of the vehicles' wheels and thrust while taxiing to and/or from a runway from UAV provided hazard information and guidance paths.

To keep the UAV 122 with fresh with information regarding already identified hazards, aggregated hazard position data uplinks 132 are also received from the hazard data aggregation system 110 by the onboard hazard data collection system 220 and stored in onboard ground hazard position data storage device 224. In one embodiment, onboard hazard detection processor 223 may implement a database update function 223-1 that updates onboard ground obstacle position database 224-1 based on the aggregated hazard position data 132 uplinks. That is, a hazard identified in the onboard ground hazard position data storage device 224 may have originated from another vehicle or UAV and communicated to the onboard ground hazard collision avoidance system 220 as aggregated hazard position data.

In one embodiment, onboard hazard detection processor 223 may evaluate the position of those hazards identified in the onboard ground hazard position data storage device 224 with respect to the UAV 122 position and communicate known nearby hazards to the escort manager 212 so that the escort manager 212 may select a path 152 or otherwise control vehicle 120 to avoid a collision with those hazards.

In one implementation, onboard collision logic processor 223 further implements a hazard sort function 223-2 that sorts out hazards sensed locally by UAV 122 into obstacles verses ground traffic. In one implementation, prior to sorting, an upload of aggregated hazard position data 132 is initiated. Based on the newly uploaded baseline data, sensed data, and sorting, onboard hazard detection processor 223 generates the UAV collected hazard position data that will be transmitted over via datalink 134 to the Ground Based Hazard Data Aggregation System 110. In one embodiment, the onboard ground obstacle position database 224-1 is synchronized with the baseline obstacle data 214. In one such embodiment, an output of UAV 112 sensed traffic position data from hazard sort function 223-2 is broadcast via datalink 134. In that case, onboard collision logic processor 223 may process the output of locally sensed obstacle position data from hazard sort function 223-2 and only broadcast (via datalink 134) differences in object positions it identifies between locally sensed obstacle position data and obstacle positions indicated by the baseline obstacle data 214.

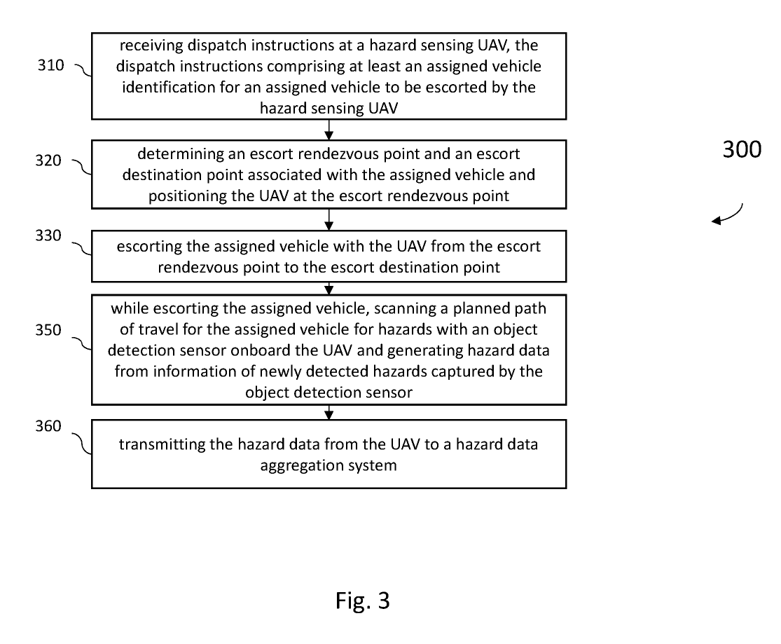

FIG. 3 is a flow chart illustrating a method 300 for on-ground vehicle collision avoidance utilizing unmanned aerial vehicles of one embodiment of the present disclosure. It should be understood that method 300 may be implemented in conjunction with any of the various embodiments and implementations described in this disclosure above or below. As such, elements of method 300 may be used in conjunction with, in combination with, or substituted for elements of those embodiments. Further, the functions, structures and other description of elements for such embodiments described herein may apply to like named elements of method 200 and vice versa.

Method 300 begins at 310 with receiving dispatch instructions at a hazard sensing UAV, the dispatch instructions comprising at least an assigned vehicle identification for an assigned vehicle to be escorted by the hazard sensing UAV. The dispatch instructions may be transmitted to the UAV as UAV management data from a vehicle control station. For example, a vehicle control station may comprise an airport control tower or other facility from which complex ground traffic is coordinate. In one embodiment, the dispatch instructions comprise an assigned vehicle identifier and may further include a designated escort rendezvous point, and/or an escort destination point. The assigned vehicle identifier may include a flight number, registration number, or some other unique identifier that defines the specific vehicle the UAV is assigned to escort. The designated escort rendezvous point indicates the location where the UAV should meet the vehicle being escorted and the escort destination point indicates the location where the UAV is to escort that vehicle to.

The method 300 proceeds to 320 with determining an escort rendezvous point and an escort destination point associated with the assigned vehicle and positioning the UAV at the escort rendezvous point. As discussed above, in some embodiments, the dispatch instructions may further specifically identify the escort rendezvous point and escort destination point. In other embodiments, the dispatch instructions may include the assigned vehicle identifier without information designating one or both of the escort rendezvous point or the escort destination point. In such an embodiment, once the assigned vehicle identifier is obtained by the dispatch instructions, the method at 320 may include monitoring communications to and from the assigned vehicle identifying one or both of the escort rendezvous point and the escort destination point from the intercepted communications. For example, in one embodiment the method at 320 may comprise monitoring communications (such as but not limited to CPDLC communications) between the assigned vehicle and an airport control tower (or other vehicle control station) to identify which runway an aircraft is clearance to land on (thus inferring an escort rendezvous point) and which gate the aircraft has been assigned to taxi to (thus inferring an escort destination point). Conversely, for a departing aircraft the method at 320 can monitor communications to identify which gate the aircraft has been cleared to push-off from (thus inferring an escort rendezvous point) and which runway the aircraft has been assigned to take-off from (thus inferring an escort destination point). Utilization of intercepted communications has the advantage of not requiring duplicative transmission of information to the UAV that has already been conveyed to the vehicle.

The method 300 proceeds to 330 with escorting the assigned vehicle with the UAV from the escort rendezvous point to the escort destination point and to 340 where while escorting the assigned vehicle, the method includes scanning a planned path of travel for the assigned vehicle for hazards with an object detection sensor onboard the UAV and generating hazard data from information of newly detected hazards captured by the object detection sensor. In one embodiment, the method further includes establishing communication between the UAV and the assigned vehicle when the assigned vehicle reaches the escort rendezvous point. In one embodiment, when escorting the assigned aircraft, the UAV via its escort manager may actually drive the vehicle. That is, it transmits control signals to control the vehicle speed and direction as it escorts the assigned vehicle to the escort destination point. In other embodiments, the UAV transmits instructions, warnings or other ques to the vehicle operator to guide the vehicle to the escort destination point. It should be noted that the exchange of a future defined ground Flight Plan from an aircraft's onboard Flight Management System with the UAV may provide finer tuning of threat generation with regards to specific aircraft.

While escorting, the UAV may control its own movements with respect to both the vehicle's motions and the designated escort path via sense and avoid technology coupled to its own path management/guidance systems. That is, when the vehicle stops, the UAV stops. When the vehicle resumes forward movements, the UAV also resumed forward movement and continues to the escort destination point. As discussed above when the UAV finds a previously unidentified hazard along the path (that is, a newly detected hazard which was previously not stored in an onboard hazard data collection system database) the method proceeds to 350 with transmitting hazard data from the UAV to a hazard data aggregation system. That is, the method transmits UAV collected hazard position data indicating the position of that new hazard to the hazard data aggregation system so that newly identified hazard may be disseminated to the assigned vehicle and other vehicle in communication with the hazard data aggregation system.

In one example implementation in operation, a hazard sensing UAV receives dispatch instructions assigning it to an arriving aircraft. On its way to the escort rendezvous point, the UAV scans the runway for runway hazards and reports newly detected hazards to the hazard data aggregation system. Prior to aircraft landing, the UAV may optionally be positioned on the runway to transmit a landing assistance signal to the aircraft, as further discussed below. Then the UAV proceeds to the rendezvous point. Once the aircraft has landed and decelerated to a speed at which the hazard sensing UAV can keep up, UAV escort of the aircraft begins and in one implementation, communication between the UAV and the aircraft may be established. The UAV then begins its physical escort of the aircraft to the designated escort destination point while sensors onboard the UAV monitor and track the aircraft ground position and speed, and maintains a distance in front of the aircraft as a function of the aircraft position and speed. In one embodiment the hazard sensing UAV may assume limited control of the aircraft, controlling its speed and movement as it taxis to the escort destination point. Along the way while the aircraft is taxiing under escort, the UAV continues to scan the path in front of the aircraft to detect when new hazards appear within that planned path. The aircraft thus receives the benefit of hazard detection along its taxi path without the need for having onboard hazard detection sensors, but instead relying on the object detection sensors equipped on the hazard sensing UAV. The UAV may send collected hazard data to the hazard data aggregation system, which can then aggregate and communicate hazards to multiple vehicles. In the case of an immediate risk (such as a fast approaching hazard) the UAV may communicate the new hazard directly to the aircrafts collision avoidance system.

In another example implementation in operation, a hazard sensing UAV receives dispatch instructions assigning it to a departing aircraft. The hazard sensing UAV meets the aircraft at its gate. The aircraft receives a preliminary clearance and departure runway assignment from the airport control tower and that information is entered into the aircraft flight management system. This information may also be received by the UAV, either by direct communication with the UAV, or by having the UAV monitor and intercept communications between the aircraft and the control tower. In some embodiments, a synchronization of the UAV with an aircraft's flight plan may be performed. Such synchronization would inherently take into account relevant information such as, but not limited to, a departure runway. The UAV then begins its physical escort of the aircraft to the designated escort destination point while sensors onboard the UAV monitor and track the aircraft ground position and speed, and maintains a distance in front of the aircraft as a function of the aircraft position and speed. In one embodiment the hazard sensing UAV may assume limited control of the aircraft, controlling its speed and movement as it taxis to the escort destination point. Along the way while the aircraft is taxiing under escort, the UAV continues to scan the path in front of the aircraft to detect when new hazards appear within that planned path. As mentioned above, the UAV may send collected hazard data to the hazard data aggregation system, which can then aggregate and communicate hazards to multiple vehicles. In the case of an immediate risk (such as a fast approaching hazard) the UAV may communicate the new hazard directly to the aircrafts collision avoidance system. Once the aircraft is delivered to the runway, the hazard sensing UAV may continue to scan the runway for hazard until the aircraft reached is takeoff speed. At that point, the UAV may disengage and leave the runway area. Alternately, a UAV may disengage from its vehicle when the vehicles speed exceeds the maximum flight velocity rating of the UAV.

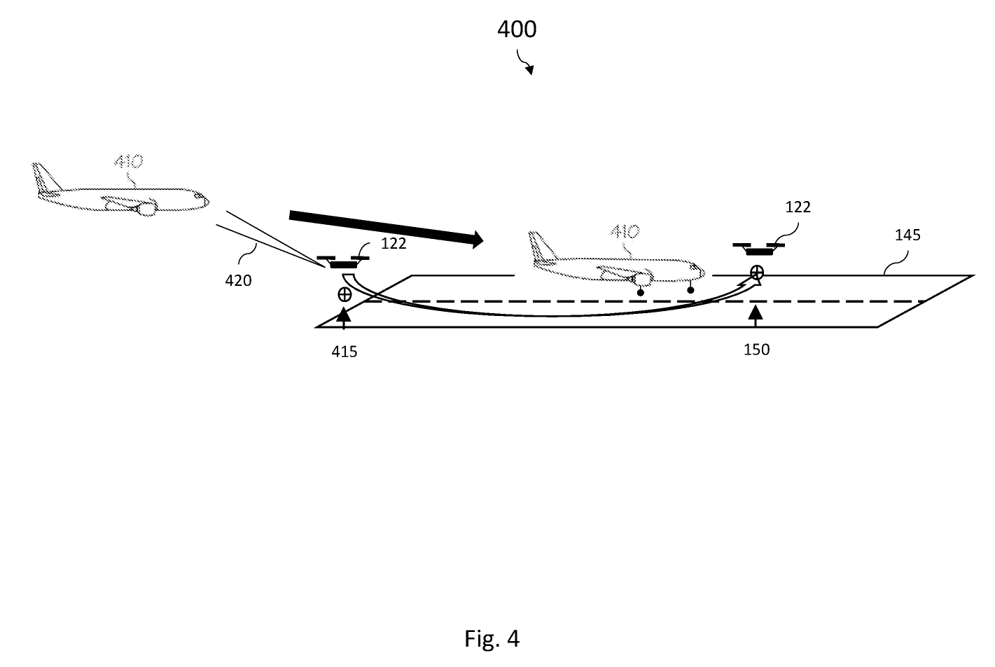

As mentioned above, in some embodiments a UAV 122 may optionally be positioned on a runway to transmit a landing assistance signal to arriving aircraft. For example, Instrument Landing System (ILS) facilities provide an accurate and dependable means of navigating an aircraft to most runways for landing. An ILS transmits narrow horizontal beams which let flight crews know if their aircraft is left, right, or directly on course for a runway. The signal transmitted by the ILS also consists of two vertical fan-shaped beam patterns that overlap at the center. Ideally, the beams are aligned with the extended centerline of the runway. The right side beam is typically referred to as the “blue” area while the left side of beam is the “yellow” area. An overlap between the two beams provides an on-track signal to aircraft. Ideally, at the point where ILS receivers on the aircraft receive blue area and yellow area beams signals of equal intensity, the aircraft is located precisely on the approach track of the runway centerline. Other systems providing landing assistance signals include, but are not limited to, a GLS (or GBAS (Ground Based Augmentation System) Landing System), Local Area Augmentation System (LAAS), FMS Landing System (FLS), and others know to those skilled in the art and referred to collectively herein as runway landing assistance systems. At airport where corresponding equipment is installed, such system may transmit beams for an approaching aircraft to follow to the runway. With some embodiments of the present disclosure, as opposed to a runway landing assistance system having permanently stationed transmitters, a UAV 122 may further be optionally equipped with an on-board landing assistance system 230 and accompanying landing assistance transmitter 232, such as indicated in FIG. 2. Then one (or more) of the UAV 122 may be dispatched to perform landing assistance service in addition to (or instead of) escort and hazard detection. Such service can be provided by flying or rolling UAVs (single or complementary) depending of the effective required stability and power transmission for such signal. FIG. 4 illustrated one such example implementation at 400. Here, upon receiving dispatch instructions for an arriving aircraft 410, the UAC 122 first takes up a position at a transmit position 415 at one end of the runway 145. Upon arriving at the transmit position 415, the on-board landing assistance system 230 is controlled by the escort manager 212 to activate landing assistance transmitter 232 to begin transmitting of a landing aid signal 420. The particular signal format and structure for the landing aid signal 415 will depending on the particular specifications of the landing system protocol being implemented, the specification for which is beyond the scope of the present disclosure but would be known to one of skill in the art who has studied this disclosure. In some implementations, a plurality of UAV 122 may be stationed at different transmit positions 415 extending out from the runway 145, forming a beam for the aircraft 410 to follow. When the aircraft 410 has landed or otherwise close to landing, the UAV 122 may proceed to the escort rendezvous point 150. From there, once the aircraft has sufficiently decelerated to a speed where the UAV 122 can keep up with the aircraft, the UAV 122 begins its escort and hazard scanning functions as described by any of the above embodiments. With such an embodiment, landing assistance services, such as ILS, can be implemented at airports otherwise lacking permanent installations, or where such permanent insulations would be difficult or cost prohibitive. In some embodiments, one or more UAV equipped as described above may be permanently dedicated to providing landing assistance services.

As mentioned above, the scope of embodiments disclosed herein is expressly contemplated to extend beyond escorting of aircraft or other ground vehicles within an airport facility to cover hazard detection for trucks, cars, busses, trains, ships, boats, and other vehicles. For example in one embodiment, a hazard sensing UAV may be assigned to escort a train as it departs a train station to scan for hazards near or on the track some distance in front of the train. The UAV may communicate newly identified hazards to a hazard aggregation system operated by the railroad company (in any of the manners described above), or communicate newly identified hazard directly to the train operator. A second example would be a hazard sensing UAV assigned to escort a boat or ship operating within a port, harbor, or shipping lane. In both of these cases, the train or ship would not need to itself be equipped with expensive sensors, but would instead benefit from the hazard data senses by a UAV escorting that vehicle.

### Example Embodiments

Example 1 includes a vehicle collision avoidance method using a unmanned aerial vehicles (UAV), the method comprising: receiving dispatch instructions at a hazard sensing UAV, the dispatch instructions comprising at least an assigned vehicle identification for an assigned vehicle to be escorted by the hazard sensing UAV; determining an escort rendezvous point and an escort destination point associated with the assigned vehicle and positioning the hazard sensing UAV at the escort rendezvous point; escorting the assigned vehicle with the hazard sensing UAV from the escort rendezvous point to the escort destination point; while escorting the assigned vehicle, scanning a planned path of travel for the assigned vehicle for hazards with at least one object detection sensor onboard the hazard sensing UAV and generating hazard data from information of newly detected hazards captured by the object detection sensor; and transmitting hazard data from the hazard sensing UAV to a hazard data aggregation system.

Example 2 includes the method of example 1, further comprising transmitting aggregated hazard position data from the hazard data aggregation system to the assigned vehicle, wherein the aggregated hazard position data includes the non-cumulative hazard data; and updating a hazard database on the assigned aircraft based on the hazard data from the hazard sensing UAV.

Example 3 includes the method of any of examples 1-2, wherein the object detection sensor comprises one or more of: a RADAR sensor; a LIDAR sensor; an infra-red camera; a visual spectrum camera; and an Electro-Optical (EO)/Infrared (IR) Sensor.

Example 4 includes the method of any of examples 1-3, wherein determining the escort rendezvous point and the escort destination point associated with the assigned vehicle comprises: reading the escort rendezvous point and the escort destination point from the dispatch instructions.

Example 5 includes the method of any of examples 1-4, wherein determining one or both of the escort rendezvous point and the escort destination point associated with the assigned vehicle comprises: monitoring a communication between the assigned vehicle and a control center; and inferring one or both of the escort rendezvous point and the escort destination point based on the communication.

Example 6 includes the method of any of examples 1-5, wherein escorting the assigned vehicle with the hazard sensing UAV from the escort rendezvous point to the an escort destination point further comprises: regulating a relative position of the hazard sensing UAV with respect to the assigned vehicle while travelling from the escort rendezvous point and the escort destination point.

Example 7 includes the method of any of examples 1-6, wherein escorting the assigned vehicle with the hazard sensing UAV from the escort rendezvous point to the escort destination point further comprises: controlling motion of the assigned vehicle from the hazard sensing UAV.

Example 8 includes the method of any of examples 1-7, wherein the assigned vehicle comprises one of: an aircraft, a helicopter, a train, a ground transportation vehicle, or a water craft.

Example 9 includes the method of any of examples 1-8, wherein the assigned vehicle is an arriving vehicle and the method further comprises: scanning an arrival runway with the at least one object detection sensor prior to vehicle arrival.

Example 10 includes the method of any of examples 1-9, further comprising: transmitting a landing assistance signal from the hazard sensing UAV prior to the assigned vehicle reaching the escort rendezvous point.

Example 11 includes the method of any of examples 1-10, wherein the assigned vehicle is a departing vehicle and the method further comprises: scanning a departure runway with the at least one object detection sensor prior to vehicle departure.

Example 12 includes the method of any of examples 1-11, wherein escorting the assigned vehicle with the hazard sensing UAV further comprises: determining an escort path from an escort rendezvous point to an escort destination point for the assigned vehicle and controlling the hazard sensing UAV to escort the assigned vehicle to follow the escort path.

Example 13 includes the method of any of examples 1-12, wherein escorting the assigned vehicle with the hazard sensing UAV further comprises: controlling the hazard sensing UAV to escort the assigned vehicle to follow the escort path at a distance in front of the assigned vehicle at least partially determined as a function of a speed of the assigned vehicle.

Example 14 includes a unmanned aerial vehicle (UAV), the vehicle comprising: a communication link transceiver; at least one object detection sensor; a vehicle escort navigation system coupled to the at least one object detection sensor and the communication link transceiver; and an on-board hazard data collection system coupled to the at least one object detection sensor and the communication link transceiver, wherein the vehicle escort navigation system is in communication with the on-board hazard data collection system; wherein the vehicle escort navigation system receives dispatch instructions via the communication link transceiver, the dispatch instructions including at least an identification for an assigned vehicle to be escorted; wherein the vehicle escort navigation system controls flight of the unmanned aerial vehicle to escort the assigned vehicle from an escort rendezvoused point to an escort destination point while the on-board hazard data collection system generates hazard data based on information collected by the at least one object detection sensor; wherein the on-board hazard data collection system transmits the hazard data to a hazard data aggregation system via the communications link transceiver.

Example 15 includes the vehicle of example 14, wherein the object detection sensor comprises one or more of: a RADAR sensor; a LIDAR sensor; an infra-red camera; a visual spectrum camera; and an Electro-Optical (EO)/Infrared (IR) Sensor.

Example 16 includes the vehicle of any of examples 14-15, wherein the vehicle escort navigation system transmits control signals to the assigned vehicle to control the vehicle speed and direction as it escorts the assigned vehicle.

Example 17 includes the vehicle of any of examples 14-16, wherein the on-board hazard data collection system further comprises: a hazard detection processor coupled to the at least one object detection sensor, wherein the hazard detection processor generates hazard data from information of newly detected hazards captured by the object detection sensor; and an onboard ground hazard position storage device coupled to the hazard detection processor.

Example 18 includes the vehicle of example 17, wherein the vehicle escort navigation system further comprises: an escort manager coupled to the at least one object detection sensor and the hazard detection processor; a UAV guidance system coupled to at least one navigation receiver; and a sense and avoid system coupled to the UAV guidance system and the escort manager; wherein the escort manager determines an escort path from an escort rendezvous point to an escort destination point for the assigned vehicle and controls the UAV guidance system to maneuver the UAV to escort the assigned vehicle to follow the escort path while autonomously maintaining a safe distance from hazards.

Example 19 includes the vehicle of examples 18, wherein the escort manager controls the UAV guidance system to maneuver the UAV to escort the assigned vehicle to follow the escort path at a distance in front of the assigned vehicle at least partially determined as a function of a speed of the assigned vehicle.

Example 20 includes the vehicle of any of examples 18-19, further comprising: an onboard landing assistance system coupled to the escort manager; and a landing assistance transmitter coupled to the onboard landing assistance system; wherein the landing assistance transmitter is controlled by the onboard landing assistance system to transmit a landing assistance signal from the UAV.

In various alternative embodiments, system elements, method steps, or examples described throughout this disclosure (such as the vehicle escort navigation systems, escort manager, sense and avoid system, onboard hazard data collection system, landing assistance system, and/or sub-parts thereof, for example) may be implemented using one or more computer systems, field programmable gate arrays (FPGAs), or similar devices and/or comprising a processor coupled to a memory and executing code to realize those elements, processes, steps or examples, said code stored on a non-transient data storage device. Therefore other embodiments of the present disclosure may include elements comprising program instructions resident on computer readable media which when implemented by such computer systems, enable them to implement the embodiments described herein. As used herein, the term “computer readable media” refers to tangible memory storage devices having non-transient physical forms. Such non-transient physical forms may include computer memory devices, such as but not limited to punch cards, magnetic disk or tape, any optical data storage system, flash read only memory (ROM), non-volatile ROM, programmable ROM (PROM), erasable-programmable ROM (E-PROM), random access memory (RAM), or any other form of permanent, semi-permanent, or temporary memory storage system or device having a physical, tangible form. Program instructions include, but are not limited to computer-executable instructions executed by computer system processors and hardware description languages such as Very High Speed Integrated Circuit (VHSIC) Hardware Description Language (VHDL).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the presented embodiments. Therefore, it is manifestly intended that embodiments be limited only by the claims and the equivalents thereof.

What is claimed is:

1. A vehicle collision avoidance method using a unmanned aerial vehicles (UAV), the method comprising:
receiving dispatch instructions at a hazard sensing UAV, the dispatch instructions comprising at least an assigned vehicle identification for an assigned vehicle to be escorted by the hazard sensing UAV;
determining an escort rendezvous point and an escort destination point associated with the assigned vehicle and positioning the hazard sensing UAV at the escort rendezvous point;
escorting the assigned vehicle with the hazard sensing UAV from the escort rendezvous point to the escort destination point;
while escorting the assigned vehicle, scanning a planned path of travel for the assigned vehicle for hazards with at least one object detection sensor onboard the hazard sensing UAV and generating hazard data from information of newly detected hazards captured by the object detection sensor; and
transmitting hazard data from the hazard sensing UAV to a hazard data aggregation system.

2. The method of claim 1, further comprising transmitting aggregated hazard position data from the hazard data aggregation system to the assigned vehicle, wherein the aggregated hazard position data includes the non-cumulative hazard data; and
updating a hazard database on the assigned vehicle based on the hazard data from the hazard sensing UAV.

3. The method of claim 1, wherein the object detection sensor comprises one or more of:
a RADAR sensor;
a LIDAR sensor;
an infra-red camera;
a visual spectrum camera; and
an Electro-Optical (EO)/Infrared (IR) Sensor.

4. The method of claim 1, wherein determining the escort rendezvous point and the escort destination point associated with the assigned vehicle comprises:
reading the escort rendezvous point and the escort destination point from the dispatch instructions.

5. The method of claim 1, wherein determining one or both of the escort rendezvous point and the escort destination point associated with the assigned vehicle comprises:
monitoring a communication between the assigned vehicle and a control center; and
inferring one or both of the escort rendezvous point and the escort destination point based on the communication.

6. The method of claim 1, wherein escorting the assigned vehicle with the hazard sensing UAV from the escort rendezvous point to the an escort destination point further comprises:
regulating a relative position of the hazard sensing UAV with respect to the assigned vehicle while travelling from the escort rendezvous point and the escort destination point.

7. The method of claim 1, wherein escorting the assigned vehicle with the hazard sensing UAV from the escort rendezvous point to the escort destination point further comprises:
controlling motion of the assigned vehicle from the hazard sensing UAV.

8. The method of claim 1, wherein the assigned vehicle comprises one of:
an aircraft, a helicopter, a train, a ground transportation vehicle, or a water craft.

9. The method of claim 1, wherein the assigned vehicle is an arriving vehicle and the method further comprises:
scanning an arrival runway with the at least one object detection sensor prior to vehicle arrival.

10. The method of claim 1, further comprising:
transmitting a landing assistance signal from the hazard sensing UAV prior to the assigned vehicle reaching the escort rendezvous point.

11. The method of claim 1, wherein the assigned vehicle is a departing vehicle and the method further comprises:
scanning a departure runway with the at least one object detection sensor prior to vehicle departure.

12. The method of claim 1, wherein escorting the assigned vehicle with the hazard sensing UAV further comprises:
determining an escort path from an escort rendezvous point to an escort destination point for the assigned vehicle and controlling the hazard sensing UAV to escort the assigned vehicle to follow the escort path.

13. The method of claim 1, wherein escorting the assigned vehicle with the hazard sensing UAV further comprises:
controlling the hazard sensing UAV to escort the assigned vehicle to follow the escort path at a distance in front of the assigned vehicle at least partially determined as a function of a speed of the assigned vehicle.

14. A unmanned aerial vehicle (UAV), the vehicle comprising:
a communication link transceiver;
at least one object detection sensor;
a vehicle escort navigation system coupled to the at least one object detection sensor and the communication link transceiver; and
an on-board hazard data collection system coupled to the at least one object detection sensor and the communication link transceiver, wherein the vehicle escort navigation system is in communication with the on-board hazard data collection system;
wherein the vehicle escort navigation system receives dispatch instructions via the communication link transceiver, the dispatch instructions including at least an identification for an assigned vehicle to be escorted;
wherein the vehicle escort navigation system controls flight of the unmanned aerial vehicle to escort the assigned vehicle from an escort rendezvoused point to an escort destination point while the on-board hazard data collection system generates hazard data based on information collected by the at least one object detection sensor;
wherein the on-board hazard data collection system transmits the hazard data to a hazard data aggregation system via the communications link transceiver.

15. The vehicle of claim 14, wherein the object detection sensor comprises one or more of:
a RADAR sensor;
a LIDAR sensor;
an infra-red camera;
a visual spectrum camera; and
an Electro-Optical (EO)/Infrared (IR) Sensor.

16. The vehicle of claim 14, wherein the vehicle escort navigation system transmits control signals to the assigned vehicle to control the vehicle speed and direction as it escorts the assigned vehicle.

17. The vehicle of claim 14, wherein the on-board hazard data collection system further comprises:
a hazard detection processor coupled to the at least one object detection sensor, wherein the hazard detection processor generates hazard data from information of newly detected hazards captured by the object detection sensor; and
an onboard ground hazard position storage device coupled to the hazard detection processor.

18. The vehicle of claim 17, wherein the vehicle escort navigation system further comprises:
an escort manager coupled to the at least one object detection sensor and the hazard detection processor;
a UAV guidance system coupled to at least one navigation receiver; and
a sense and avoid system coupled to the UAV guidance system and the escort manager;
wherein the escort manager determines an escort path from an escort rendezvous point to an escort destination point for the assigned vehicle and controls the UAV guidance system to maneuver the UAV to escort the assigned vehicle to follow the escort path while autonomously maintaining a safe distance from hazards.

19. The vehicle of claim 18, wherein the escort manager controls the UAV guidance system to maneuver the hazard sensing UAV to escort the assigned vehicle to follow the escort path at a distance in front of the assigned vehicle at least partially determined as a function of a speed of the assigned vehicle.

20. The vehicle of claim 18, further comprising:
an onboard landing assistance system coupled to the escort manager; and
a landing assistance transmitter coupled to the onboard landing assistance system;
wherein the landing assistance transmitter is controlled by the onboard landing assistance system to transmit a landing assistance signal from the UAV.
